(19) United States
(12) Patent Application Publication
(10) Pub. No.: US 2003/0031305 A1
(43) Pub. Date: Feb. 13, 2003

(54) Phone service provisioning

(76) Inventors: Eran Netanel, San Mateo, CA (US); Serge Plotkin, Belmont, CA (US); Alon Segal, San Francisco, CA (US)

Correspondence Address: GLENN PATENT GROUP, 3475 EDISON WAY, SUITE L, MENLO PARK, CA, 94025, US

(21) Appl. No.: 10/203,481

(22) PCT Filed: Feb. 9, 2001
(86) PCT No.: PCT/US01/04319

(51) Int. Cl. H04M 3/42

(52) U.S. Cl. 379/201.12

(57) ABSTRACT

A method and apparatus is disclosed which provides for the switching from service providers on dial-up connection. A user connection device like a cellular phone is programmed to receive command functions. The command functions allow the user to navigate across services provided through the dial-up connection. Once a first service is activated, a second service can be connected to automatically by selecting from a menu option. Navigation can also be performed by voice activation.

### BACKGROUND OF THE INVENTION

1. Technical Field

The invention relates to services accessible by wireless devices. More particularly, the invention relates to an apparatus and to a family of methods that provide for the installation, and use of various services that are accessible by wireless devices, without integration of the services into the system of the wireless service provider.

2. Description of the Prior Art

Voice messaging, online stock trading, voice mail, and web browsing are examples of services currently offered to wireless subscribers. For a service provider (SP) to enable such a service, he must contact a phone service provider (PSP) i.e. AT&T, and obtain such information as a phone number and a pricing plan. Once a service is enabled, a user can access such service by calling the phone number.

Currently, if a user wants to switch from one service to another, the service must be tightly integrated into the PSP's system. Such tight integration includes building protocols, messaging, modifying the billing system etc. Alternatively, for a user to use multiple systems, he must hang up, look up each service number, and dial it himself. The user must repeat this process to move from service to service. Where the service is integrated, the switching is performed internally by the PSP. For example, if a user is checking his voice mail and then wants to do some online stock trading, the termination of the voice mail and connection to the online stock trading is performed by the PSP.

This present system has many problems associated with it. For example, a high turnaround time is required to bring a service into such an integrated network. Sometimes this period may take as long as a year. There is also a high cost to implement such services. Similarly, there is a high cost and turnaround time to remove such a system. One reason for this is that there exist several standards that define network architectures, such as TDMA, CDMA and MAP for GSM.

U.S. Pat. No. 5,960,072, Hird et al., Method and Apparatus for Altering the Access Format of Telephone Calls, (Sep. 28, 1999), discloses a pay telephone system having a telecommunication node that automatically completes calls that would otherwise require the services of a live operator. The pay telephone system does this by receiving the telephone number of the user of the node. It then alters the access format of the number, from a format that is billed directly to a remote location, to one that is billed to the local station. While this invention teaches the tracking of a telephone number and altering the access format, this invention does not teach a method or apparatus for navigating through services.

U.S. Pat. No. 5,862,475, Zicker, Communication System that Supports Wireless Remote Programming Process, (Jan. 19, 1999) discloses the switching of dial-up calls from one system to another. A person using a wireless communication product, such as a cellular phone, is automatically switched from a standard cellular telephone mode to an enhanced cordless mode when in close proximity to an enhanced cordless system. The goal of this system is to provide high quality and continuous wireless connections for a user. While Zicker does disclose the switching of a wireless connection, the switching is done between carrier modes, not between services.

What is needed is a way to provide services to a wireless customer that is not overly cumbersome and costly to an SP. What is also needed is a way to provide services that are seamless and easy to use by an end-user.

### SUMMARY OF THE INVENTION

A method and apparatus is disclosed which provides for the switching from service providers, on dial-up or data connection. A user connection device, such as a cellular phone, is programmed to receive command functions and lists. The command functions lists allow the user to navigate through and across services provided through the dial-up connection. Once a first service is connected, a second service can be connected to automatically, or by selecting from a menu option. Command functions can also be performed and stored by a network node. Navigation can also be performed by voice. The cellular phone receives command functions by a navigator service, either through a data transmission from a dial-up or data messaging connection.

### BRIEF DESCRIPTION OF THE DRAWINGS

FIG. 1 is a block schematic diagram showing an overall system view of a service system according to the invention; and

FIG. 2 is a flowchart, which illustrates connecting and switching services for a navigator service according to the invention.

### DESCRIPTION OF THE PREFERRED EMBODIMENT

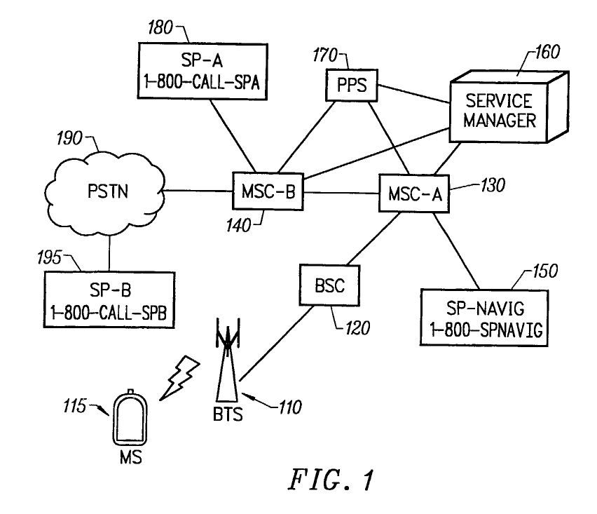

FIG. 1 is a block schematic diagram that illustrates the relationship between several elements of the invention.

The mobile station (MS) 115 is the wireless device by which a user accesses various services. Typically, the wireless device is a cell phone or personal digital assistant. It is contemplated that a landline phone can also be used. The MS is modified so that it can receive and store command function (discussed infra). The modification can come in the form of modifying the existing technology of the phone, or by adding a microchip capable of receiving and storing the functions. Where an MS cannot receive command functions, a service manager (discussed infra) is used to send and store command functions.

The MS 115 communicates through a base transmission station (BTS) 110. The BTS 110 is a radio transmitter and receiver, and it facilitates communication between the MS 115 and a base station controller (BSC) 120. An example of such a BTS 110 is the QUANTAR produced by Motorola of Schaumburg, Ill.

The BSC 120 interfaces one or more MS's to a dispatcher communications network. The BSC helps transition communications systems from conventional analog voice networks to state-of-the-art digital technologies. An example of such a BSC 120 is the Universal Base Station Controller (UBSC), A47720 produced by Safetran of Louisville, Ky.

The mobile switching center (MSC) 130,140 is an automatic cellular mobile system, providing the interface between the radio system and the public switched telephone network. The MSC performs all signaling functions that are necessary to establish calls to and from mobile stations. It also defines the services that operators can offer to mobile phone users to differentiate themselves. Also, the MSC may interface between the radio system and a prepay system (PPS) 170, a service manager 160, a service provider 150, 180, or another MSC.

A PPS 170 generally refers to calling plans where payment is made in advance, and a certain amount of time is allotted for the use of calling privileges. Such privileges include calling cards and wireless phones. Once a user has spent his prepayment amount, he must renew or his privileges end. As a user switches from plan to plan, the rate at which the user is charged is also changed to reflect the current plan used. It is contemplated that a post payment system would also function as a payment system.

The PPS tracks the time of use by the user, and makes charges based upon a predetermined rate. The rate is calculated from many factors such as, airtime, charge for first minute, bandwidth rate etc. Another factor is the service used. Each service has its own rate. A service provider provides their rate plan to the PPS so that the PPS can calculate the amount to charge a user. For example, the voice mail rate may be two cents per minute, while the checking email rate may be three cents a minute. The system tracks a subscriber's use by the telephone number of the wireless device.

A service manager 160 provides service management functions for one or more MS's that want to navigate through a service but do not have command list reception. The service manager does so through a command list interpreter. The service manager is tightly integrated with the MSC and PPS to drop and forward calls, without dropping the MS connection. A service provider (SP) uploads the command function to the service manager, rather than the MS. The service manager receives instructional input from the MS, and the service manager then directs the MSC to connect the MS to the user chosen SP.

For a cellular phone, one method of selecting options is by using the keypad. The tone signals generated by the cell phone are used as the input signal to indicate a selection. The service manager integration is done by standard means for wireless networks, such as Customized Application for Mobile network Enhanced Logic (CAMEL) for GSM. The method of integration is well understood in the art, and is not disclosed in greater detail herein.

A SP 150,180,195 is a company that offers their product or service, accessible through an MS 115. Typical kinds of service offered are those that can be implemented over a cell phone or PDA. Some examples are, voice messaging, online stock trading, voice mail, and web browsing. When a service is accessed, a command list, typically a menu of options, allows navigation through the services. Examples of commands are, dial number, open data connection, connect for an x amount of time, query user for selection, disconnect and exit.

A navigator service (SPN) 150 is a service offered by an SP (or by the PSP) and provides directory service for other services offered by other SPs from which a user can be forwarded to a selected service. When a user connects to a SPN multiple service are offered from which the user can connect to, using a command function list uploaded by the SPN to the MS. Depending on the command list and the availability of the service manager this could be done without having to terminate one connection, and reconnecting to another. For example, a user connects to a SPN through his cellular phone. The user is given a list on services from which he can connect. The selections are, for keypad selection one, voice mail, keypad selection two, online trading, etc. The user may switch between each of these choices without disconnecting and dialing the next service.

A public switched telephone network (PSTN) 190 is a landline access. An MS 115 can connect to the PSTN 190 and access a service provider (SPB) 195 that is available through the PSTN 195.

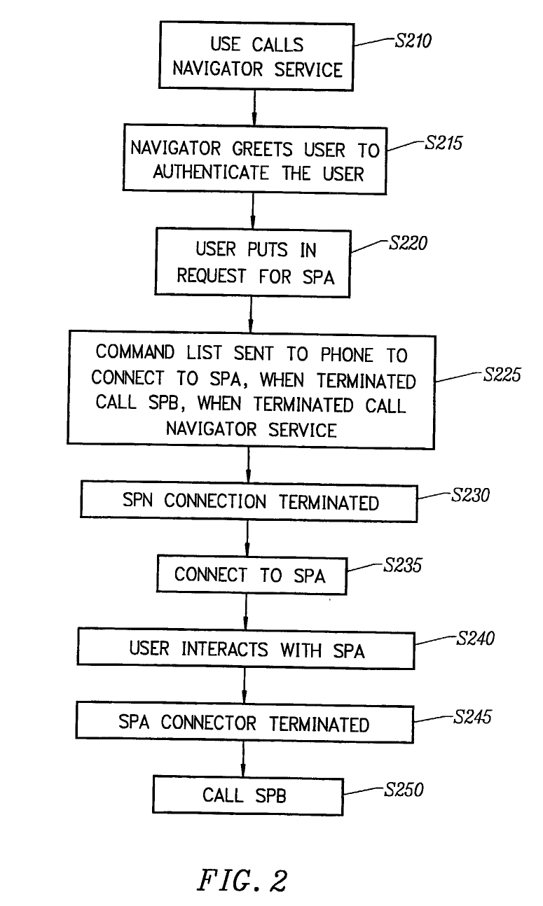

FIG. 2 is a flowchart that illustrates how a user goes through the process of connecting to a service, through a navigator service, and then subsequently changing from one service to another service. The flowchart is also illustrative of the similar process where switching is performed outside a navigator service.

A user starts connecting to a service by first dialing the navigator service S210. After the call connects, the user receives a descriptive greeting S215 letting him know which navigator service he has dialed.

Dual authentification occurs at this time. Authentification can occur at any point where there is an exchange of data. For example, the SP authenticates that the MS has proper authorization to access the system, and also checks the services to which the MS has access. The MS also authenticates the SP to ensure that it is properly authorized. The authentication is used to ensure that the proper user is billed, and that the user is billed correctly. Also, it ensures that there is no unauthorized switching of services.

The user then requests a service S220. Selecting a service causes the navigator service to send a command list, and command function to the MS S225. The command functions in this example are, connect to a first service provider (SPA), when SPA connection terminated, connect to a second service provider (SPB), when connection to SPB is terminated, connect to SPN.

The MS terminates the connection to the SPN S230 and connects to the SPA S235. Examples of command functions are, terminate call, connect to SP, etc. Command functions can also be uploaded while a SP is being used. This usually occurs where the SPB was selected, but becomes unavailable while the SPA is being used. The uploaded command functions can offer an alternate mirror site, that the user can connect to or when SPB want to forward the user to additional SPs.

If for example, the SPA is voice mail, the user spends his desired amount of time checking his voice mail S240. The command list can also be updated on the fly as long as the user is connected to the system.

In another embodiment, the command list is sent through a data connection band like short messaging service (SMS).

Services can be offered to the user as links, while he is using the SPA. The user can, for example, select a SPB, continue with the SPA, or terminate the SPA. The new service is presented in a variety of ways, depending on the type of MS. If the MS is a PDA then the interface can have a descriptive button. To change to the SPB, the user need just highlight and select a descriptive button. Similarly, if the MS is a cell phone, such as the Nokia 6190, the user selects the menu, then scrolls using the up and down pad until he reaches the selection services. Selection of the service option brings the user to a selection of services available.

When the user selects the SPB, the SPA connection is terminated S245. The phone then connects to the SPB automatically S250. The user is then able to navigate and use the SPB250.

In another embodiment, after terminating the SPA, the MS downloads a command list for the SPB while connected to the SPA, before connecting to the SPB.

In another embodiment of the invention, voice commands can be used. The voice command can be used to implement any function on the phone or PDA. For example, if a user wishes to check his voice mail he could say “voice mail” and the preprogrammed number is dialed. The dialing of the number gives the user access to his voice mail service. The user can then navigate through the service using voice commands. Some examples of navigational voice commands for voice mail are, next message, previous message, delete, save, and skip.

Voice commands can also be used to switch services. For example, if the user now desires to switch from checking his voice mail to do some online stock trading, he could then say “online stock trading.” The phone then disconnects and dials the online stock trading number. The voice recognition ability can be embedded either in the MS, or as another service provided. Where a site does not have voice recognition, a voice translator may be used to convert voice commands to DTMF tones.

The voice command ability also provides for a MS that has no keypad as described in co-pending patent application Ser. No. 09/337,050. In this embodiment, a MS is programmed to dial a single number that connects a user to the service provider system. The single number could be a number of ways to connect to a service including a service navigator, service manager or a SP.

In another embodiment, the MS does not terminate the first service before connecting to the second service. An MS can have dual line features, commonly referred to as call waiting. A user can use the second line to dial and connect to a second service. The user can then switch back and forth between both services without terminating either.

In another embodiment, a data transport layer, like SMS, can be used to connect to a second service.

In another embodiment, advertorial content is submitted to a user. The advertorial content can be submitted through a dial-up connection, or through a data connection. For example, a user selecting a service, is first dialed into an advertiser to hear a commercial, before he is connected to the service. In another example, the advertorial content is delivered as command functions while a user is using a service. The command functions may give the user additional, optional services.

In another embodiment, a SP can read the command functions of a MS to see what other SP's a user has connected to, and will connect to. A SP can use this information to offer substitute services or billing plans, for example if this user heard a specific advertisement the service would be provided no charge.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for switching telephone accessible services comprising:
connecting a service accessing means to a service provider; and
uploading command functions from said service provider, to said service accessing means.

2. The method of claim 1, further comprising:
selecting a command.

3. The method of claim 1, further comprising:
connecting to a second service.

4. The method of claim 3, wherein said second connection is made through a second connection means.

5. The method of claim 4, wherein said second connection means is a second line of a dual line.

6. The method of claim 4, wherein said second connection means is a data connection band.

7. The method of claims 1 or 3, wherein said connection is performed through a wireless system.

8. The method of claims 1 or 3, wherein said connection is performed through a wired system.

9. The method of claim 1, wherein said service accessing means, comprise any of:
a phone, cellular phone, personal digital assistant, computer, and network node.

10. The method of claim 9, wherein said network node is integrated with said service manager using Customized Application for Mobile network Enhanced Logic (CAMEL).

11. The method of claim 9, wherein said network node is a navigator service which provides a directory service to select between services.

12. The method of claim 1, wherein said service accessing means has a menu system providing navigation through said service.

13. The method of claim 1, wherein said command functions comprise any of:
dial number, open data connection, connect for an x amount of time, query user for selection, disconnect and exit.

14. The method of claim 1, wherein said service provider comprise any of:
stock trading, voice mail, email, and web browsing.

15. The method of claim 3, further comprising:
terminating said first service before connecting to said second service.

16. The method of claim 1, wherein said service accessing means has voice command recognition capabilities.

17. The method of claim 16, wherein said service accessing means has no keypad.

18. The method of claim 1, wherein said uploading of command functions is sent through a data transport band.

19. The method of claim 1, further comprising:
authenticating said service accessing means.

20. The method of claim 1, further comprising:
authenticating said service provider.

21. An apparatus for switching telephone accessible services comprising:
means for connecting a service accessing means to a service provider; and
means for uploading command functions from said service provider, to said service accessing means.

22. The apparatus of claim 21, further comprising:
means for selecting a command.

23. The apparatus of claim 21, further comprising:
means for connecting to a second service.

24. The apparatus of claim 23, wherein said second connection is made through a second connection means.

25. The apparatus of claim 24, wherein said second connection means is a second line of a dual line.

26. The apparatus of claim 24, wherein said second connection means is a data connection band.

27. The apparatus of claims 21 or 23, wherein said connection is performed through a wireless system.

28. The apparatus of claims 21 or 23, wherein said connection is performed through a wired system.

29. The apparatus of claim 21, wherein said service accessing means, comprise any of:
a phone, cellular phone, personal digital assistant, computer, and network node.

30. The apparatus of claim 29, wherein said network node is integrated with said navigator service using Customized Application for Mobile network Enhanced Logic (CAMEL).

31. The apparatus of claim 29, wherein said network node is a navigator service that provides a portal between services.

32. The apparatus of claim 21, wherein said service accessing means has a menu system providing navigation through said service.

33. The apparatus of claim 21, wherein said command functions comprise any of:
dial number, open data connection, connect for an x amount of time, query user for selection, disconnect, and exit.

34. The apparatus of claim 21, wherein said service provider comprise any of:
stock trading, voice mail, email, and web browsing.

35. The apparatus of claim 23, further comprising:
means for terminating said first service before connecting to said second service.

36. The apparatus of claim 21, wherein said service accessing means has voice command recognition capabilities.

37. The apparatus of claim 36, wherein said service accessing means has no keypad.

38. The apparatus of claim 21, wherein said uploading of command functions is sent through a data transport band.

39. The apparatus of claim 21, further comprising:
means for authenticating said service accessing means.

40. The apparatus of claim 21, further comprising:
means for authenticating said service provider.
